(19) United States
(12) Patent Application Publication
(10) Pub. No.: US 2017/0002244 A1
(43) Pub. Date: Jan. 5, 2017

(54) WORKING FLUID FOR HEAT CYCLE, COMPOSITION FOR HEAT CYCLE SYSTEM, AND HEAT CYCLE SYSTEM

(71) Applicant: Asahi Glass Company, Limited, Chiyoda-ku (JP)

(72) Inventors: Masato FUKUSHIMA, Chiyoda-ku (JP); Mai Tasaka, Chiyoda-ku (JP); Katsuya Ueno, Chiyoda-ku (JP); Hidekazu Okamoto, Chiyoda-ku (JP); Katsuya Fujii, Chiyoda-ku (JP); Toshiyuki Tanaka, Chiyoda-ku (JP)

(73) Assignee: Asahi Glass Company, Limited, Chiyoda-ku (JP)

(21) Appl. No.: 15/263,777

(22) Filed: Sep. 13, 2016

Related U.S. Application Data
(63) Continuation of application No. PCT/JP2015/057904, filed on Mar. 17, 2015.

(30) Foreign Application Priority Data
Mar. 18, 2014 (JP) 2014-055605

(51) Int. Cl. C09K 5/04; C10M 171/00

(52) U.S. Cl. CPC C09K 5/045; C10M 171/008; C09K 2205/22; C09K 2205/122; C09K 2205/126; C10N 2240/30; C10N 2220/302; C10M 2207/2835; C10M 2209/1033; C10M 2209/043; F25B 2400/12

(57) ABSTRACT

To provide a working fluid for heat cycle which has high durability, which is excellent in the compatibility with a greater variety of refrigerant oils, and which is excellent in the cycle performance (capacity), a composition for a heat cycle system, and a heat cycle system. A working fluid for heat cycle, which contains trifluoroethylene and difluoromethane, wherein the proportion of the total amount of trifluoroethylene and difluoromethane based on the entire amount of the working fluid for heat cycle is higher than 90 mass %, and the mass ratio represented by trifluoroethylene/difluoromethane in the working fluid for heat cycle is from 21/79 to 39/61, a composition for a heat cycle system, and a heat cycle system employing the composition.

### TECHNICAL FIELD

The present invention related to a working fluid for heat cycle containing trifluoroethylene and difluoromethane, a composition for a heat cycle system comprising the working fluid, and a heat cycle system.

### BACKGROUND ART

Heretofore, as a working fluid such as a refrigerant for a refrigerator, a refrigerant for an air-conditioning apparatus, a working fluid for a power generation system (such as exhaust heat recovery power generation), a working fluid for a latent heat transport apparatus (such as a heat pipe) or a secondary cooling fluid, a chlorofluorocarbon (CFC) such as chlorotrifluoromethane or dichlorodifluoromethane or a hydrochlorofluorocarbon (HCFC) such as chlorodifluoromethane has been used. However, influences of CFCs and HCFCs over the ozone layer in the stratosphere have been pointed out, and their use is regulated at present. In this specification, abbreviated names of halogenated hydrocarbon compounds are described in brackets after the compound names, and the abbreviated names are employed instead of the compound names as the case requires.

Under the above conditions, as a working fluid for heat cycle, a hydrofluorocarbon (HFC) which has less influence over the ozone layer, such as difluoromethane (HFC-32), tetrafluoroethane or pentafluoroethane (HFC-125) has been used. For example, R410A (a pseudoazeotropic mixture of HFC-32 and HFC-125 in a mass ratio of 1:1) is a refrigerant which has been widely used. However, it is pointed out that HFCs may cause global warming. Accordingly, development of a working fluid for heat cycle which has less influence over the ozone layer and has a low global warming potential and which can replace R410A, is an urgent need.

As a working fluid for heat cycle, a hydrofluoroolefin (HFO) having a carbon-carbon double bond has been used, which has less influence over the ozone layer and has less influence over global warming, since the carbon-carbon double bond is likely to be decomposed by OH radicals in the air.

As a HFO to be used for the working fluid for heat cycle, for example, Patent Document 1 proposes 3,3,3-trifluoropropene (HFO-1243zf), 1,3,3,3-tetrafluoropropene (HFO-1234ze), 2-fluoropropene (HFO-1261yf), 2,3,3,3-tetrafluoropropene (HFO-1234yf) and 1,1,2-trifluoropropene (HFO-1243yc).

Further, as a HFO used as a working fluid for heat cycle, Patent Document 2 discloses 1,2,3,3,3-pentafluoropropene (HFO-1225ye), trans-1,3,3,3-tetrafluoropropene (HFO-1234ze(E)), cis-1,3,3,3-tetrafluoropropene (HFO-1234ze(Z)) or HFO-1234yf.

As a working fluid for heat cycle having excellent refrigerant performance, a composition comprising trifluoroethylene (HFO-1123) (for example, Patent Document 3) has been known. Patent Document 3 also discloses an attempt to obtain a working fluid comprising HFO-1123 and various HFCs or HFOs in combination for the purpose of increasing the flame retardancy, cycle performance, etc. of the working fluid.

However, HFOs disclosed in Patent Documents 1 and 2 are insufficient in the cycle performance (capacity) and among such HFOs, one having a low proportion of fluorine atoms has combustibility. Further, HFOs disclosed in Patent Document 2 are also insufficient in the cycle performance (capacity).

Further, HFO-1123, which has a double bond in its molecule, is likely to undergo self-polymerization reaction when held at high temperature for a long period of time, and when a composition containing HFO-1123 is to be practically used, its durability has to be improved. If HFO-1123 contained in the working fluid for heat cycle undergoes self-polymerization reaction, the content of HFO-1123 in the working fluid for heat cycle decreases, thus leading to a decrease in the cycle performance (capacity) of the working fluid for heat cycle or a decrease in the energy efficiency of the heat cycle system.

Further, Patent Document 3 failed to disclose or suggest to obtain a working fluid comprising HFO-1123 and a HFC or another HFO in combination with a view to obtaining a working fluid for heat cycle which is practically useful comprehensively considering the balance of the capacity, the efficiency and durability.

Further, when the working fluid for heat cycle is to be applied to a heat cycle system, there is a problem regarding the compatibility with a refrigerant oil usually contained, in addition to the working fluid for heat cycle, in the composition for a heat cycle system. If the compatibility between the working fluid for heat cycle and the refrigerant oil is low, the refrigerant oil may not sufficiently circulate in the heat cycle system. Accordingly, it has been necessary to select a refrigerant oil having favorable compatibility with the working fluid for heat cycle from among a variety of refrigerant oils.

Accordingly, a working fluid for heat cycle which has sufficiently high cycle performance (capacity), which is excellent in the durability and which is excellent in the compatibility with a greater variety of refrigerant oils, has been desired.

### PRIOR ART DOCUMENTS

### Patent Documents

Patent Document 1: JP-A-4-110388

Patent Document 2: JP-A-2006-512426

Patent Document 3: WO2012/157764

### DISCLOSURE OF INVENTION

### Technical Problem

It is an object of the present invention to provide a working fluid for heat cycle which is excellent in durability and is excellent in the compatibility with a greater variety of refrigerant oils, a composition for a heat cycle system comprising the working fluid, and a heat cycle system employing the composition.

### Solution to Problem

The present invention provides the following working fluid for heat cycle, composition for a heat cycle system and heat cycle system.
[1] A working fluid for heat cycle, which contains trifluoroethylene and difluoromethane, wherein the proportion of the total amount of trifluoroethylene and difluoromethane based on the entire amount of the working fluid for heat cycle is higher than 90 mass % and at most 100 mass %, and the mass ratio represented by trifluoroethylene/difluoromethane in the working fluid for heat cycle is from 21/79 to 39/61.
[2] The working fluid for heat cycle according to [1], wherein the mass ratio represented by trifluoroethylene/difluoromethane in the working fluid for heat cycle is from 23/77 to 39/61.
[3] The working fluid for heat cycle according to [1], wherein the mass ratio represented by trifluoroethylene/difluoromethane in the working fluid for heat cycle is from 23/77 to 37/63.
[4] The working fluid for heat cycle according to [1], wherein the mass ratio represented by trifluoroethylene/difluoromethane in the working fluid for heat cycle is from 25/75 to 37/63.
[5] The working fluid for heat cycle according to [1], wherein the mass ratio represented by trifluoroethylene/difluoromethane in the working fluid for heat cycle is from 25/75 to 35/65.
[6] The working fluid for heat cycle according to any one of [1] to [5], wherein the proportion of the total amount of trifluoroethylene and difluoromethane based on the entire amount of the working fluid for heat cycle is higher than 97 mass % and at most 100 mass %.
[7] A composition for a heat cycle system, which comprises the working fluid for heat cycle as defined in any one of [1] to [6] and a refrigerant oil.
[8] The composition for a heat cycle system according to [7], wherein the refrigerant oil is at least one member selected from an ester refrigerant oil, an ether refrigerant oil and a fluorinated refrigerant oil.
[9] The composition for a heat cycle system according to [8], wherein the ester refrigerant oil is a polyol ester oil.
[10] The composition for a heat cycle system according to [8], wherein the ether refrigerant oil is a polyalkylene glycol oil.
[11] The composition for a heat cycle system according to [8], wherein the ether refrigerant oil is a polyvinyl ether.
[12] A heat cycle system, which employs the composition for a heat cycle system as defined in any one of [7] to [11].
[13] The heat cycle system according to [12], which is a refrigerating apparatus, an air-conditioning apparatus, a power generation system, a heat transport apparatus or a secondary cooling machine.
[14] The heat cycle system according to [12], which is a room air-conditioner, a store package air-conditioner, a building package air-conditioner, a plant package air-conditioner, a gas engine heat pump, a train air-conditioning system, an automobile air-conditioning system, a built-in showcase, a separate showcase, an industrial fridge freezer, an ice making machine or a vending machine.

### Advantageous Effects of Invention

The working fluid for heat cycle and the composition for a heat cycle system of the present invention have high durability and are excellent in the compatibility with a greater variety of refrigerant oils.

Further, the heat cycle system of the present invention, which employs the working fluid for heat cycle of the present invention, has high durability, and is excellent in the cycle performance (capacity) and the energy efficiency.

### BRIEF DESCRIPTION OF DRAWINGS

FIG. 1 is a schematic construction view illustrating an example of a refrigerating cycle system.

FIG. 2 is a cycle diagram illustrating the state change of a working fluid for heat cycle in a refrigerating cycle system on a pressure-enthalpy chart.

### DESCRIPTION OF EMBODIMENTS

Now, the present invention will be described in detail.

### [Working Fluid for Heat Cycle]

The working fluid for heat cycle of the present invention is a working fluid for heat cycle containing HFO-1123 and HFC-32, wherein the proportion of the total amount of HFO-1123 and HFC-32 based on the entire amount of the working fluid for heat cycle is higher than 90 mass % and at most 100 mass %. Further, the mass ratio represented by HFO-1123/HFC-32 in the working fluid for heat cycle is from 21/79 to 39/61. In this specification, unless otherwise specified, the ratio represented by HFO-1123/HFC-32 means a mass ratio.

The working fluid for heat cycle of the present invention is a mixture of HFO-1123 with HFC-32 with a lowered content of HFO-1123, whereby the self-polymerization reaction can be prevented. In a case where the working fluid for heat cycle of the present invention is applied to a heat cycle system, the temperature conditions are usually at a level of 130° C. or lower. Further, the pressure conditions of the heat cycle system are usually at a level of 5 MPa (gauge pressure, the same applies hereinafter). Accordingly, since the working fluid for heat cycle comprising HFO-1123 and HFC-32 is less likely to undergo self-polymerization reaction under a pressure of 5 MPa at a temperature of 130° C. for at least 30 years, such a working fluid for heat cycle has high durability under conventional pressure and temperature conditions under which the working fluid is applied to a heat cycle system, and has high long-term reliability.

### (Self-Polymerizability)

The self-polymerizability of the working fluid for heat cycle may be evaluated, for example, as follows. Assuming that a composition (working fluid for heat cycle) comprising HFO-1123 and HFO-32 in a predetermined proportion is enclosed in a closed container, the reacting weight by polymerization of HFO-1123 after a predetermined time under predetermined temperature and pressure conditions is calculated. The smaller the reacting weight is, the lower the self-polymerizability of the working fluid for heat cycle of the composition can be evaluated. The reacting weight may be calculated employing the reaction rate constant k of the polymerization reaction of HFO-1123 by itself under the above predetermined temperature and pressure conditions. The reaction rate constant k of the polymerization reaction of HFO-1123 may be obtained by a known method, for example, from the experimentally obtained polymerization reaction rate of HFO-1123.

The self-polymerizability may be evaluated, specifically, as follows. Employing the reaction rate constant k (130° C.)=2.40×10⁻¹⁰ [L•mol⁻¹·s⁻¹] of the polymerization reaction of HFO-1123 at a temperature of 130° C. represented by the following formula (1), the reaction molar amount in 30 years by the polymerization reaction of HFO-1123 in the working fluid for heat cycle of a predetermined composition is calculated.

Reaction rate constant k (130° C.)=A_{0Xexp}(−ΔE/RT) (1)

In the above formula (1),

A₀ is the frequency factor (A₀=7.0×10⁷ [L·mol⁻¹·s⁻¹]),

ΔE is the activation energy in the polymerization reaction of HFO-1123 (ΔE=1.3×10⁵ [J·mol⁻¹]),

R is the gas constant, and

T is the temperature in the container (T=403 [K]). Further, A₀ and ΔE are values measured by Japan Carlit Co., Ltd.

The reaction molar amount by polymerization of HFO-1123 may be calculated in accordance with chemical kinetics employing the initial molar concentration of HFO-1123 in the working fluid for heat cycle of a predetermined composition, the elapsed time and the above reaction rate constant k (130° C.) under conditions that the polymerization reaction of HFO-1123 is a second-order reaction.

The HFO-1123 remaining ratio after 30 years in the working fluid for heat cycle of the above composition is calculated from the obtained reaction molar amount in 30 years and the initial molar amount of HFO-1123 in the working fluid for heat cycle of the composition. The remaining ratio after 30 years is defined by the percentage of the molar amount of HFO-1123 in the working fluid for heat cycle after a lapse of 30 years under the above pressure and temperature conditions based on the molar amount of HFO-1123 contained in the initial working fluid for heat cycle.

Of the working fluid for heat cycle of the present invention, the preferred composition ratio of HFO-1123 and HFC-32 for evaluation of the self-polymerizability may be determined by employing as an index the HFO-1123 remaining ratio after 30 years under conditions of 5 MPa and 130° C. calculated by employing the reaction rate constant k (130° C.). The remaining ratio after 30 years is preferably at least 90.0%, more preferably at least 90.5%, further preferably at least 91.0%. When the remaining ratio after 30 years is at least 90.0%, a working fluid for heat cycle excellent in the long-term durability can be obtained.

### (Compatibility)

Further, when the working fluid for heat cycle of the present invention is applied to a heat cycle system, as described hereinafter, it is usually used as a composition for a heat cycle system with a refrigerant oil. The refrigerant oil is required to circulate in the heat cycle system together with the working fluid for heat cycle. Accordingly, the compatibility between the working fluid for heat cycle and the refrigerant oil is preferably as high as possible. Heretofore, a variety of compounds have been proposed as the refrigerant oil. Depending upon the composition of the working fluid for heat cycle, the compatibility with some refrigerant oils among the variety of refrigerant oils may be low. Accordingly, in order that the working fluid for heat cycle of the present invention is a working fluid for heat cycle which is excellent in the compatibility with a greater variety of refrigerant oils and has high general-purpose properties, a composition with a mass ratio represented by HFO-1123/HFC-32 of at least 21/79 is selected. The working fluid for heat cycle of the present invention is not only excellent in the general-purpose properties but also excellent in the compatibility with refrigerant oils, and accordingly, it can provide excellent cycle performance by letting the refrigerant oil sufficiently circulate over a long period of time. Further, by such a working fluid, a heat cycle system with a higher efficiency can be obtained. Further, since the working fluid has high general-purpose properties, an effect can be expected that the structure of equipment for the heat cycle system to which the working fluid for heat cycle is applied can be simplified.

The compatibility between the working fluid for heat cycle of the present invention and the refrigerant oil is evaluated by the interaction distance R between the working fluid for heat cycle and the refrigerant oil as determined from the Hansen Solubility Parameters (hereinafter sometimes referred to as HSP).

HSP are represented by three parameters δ_{D}, δ_{P} and δ_{H}, each measured in the unit (MPa)^{1/2}, based on solubility parameters developed by Hildebrand, under a condition that the following formula (2) is satisfied. δ_{D} is HSP by an effect from dispersion forces between molecules, δ_{P} is HSP by an effect from bipolar intermolecular force between molecules, and δ_{H} is HSP by an effect from hydrogen bonds between molecules.

δ²=δ_{D}²+δ_{P}²+δ_{H}² (2)

In this specification, the interaction distance (Ra) between two substances is a value calculated in accordance with the following formula (3):

(Ra)={(2δ_{D1}−2δ_{D2})²+(δ_{P1}−δ_{P2})²+(δ_{H1}−δ_{H2})²}^{1/2} (3)

In the formula (3), the subscript 1 and 2 respectively represent the HSP of the substance 1 and the substance 2.

The definition and the calculation method of HSP and the interaction distance are disclosed in the following article.

Charles M. Hansen, Hansen Solubility Parameters: A Users Handbook (CRC Press, 2007)

According to the article, HSP of a mixture are determined from HSP of substances mixed and the volume mixture ratio in accordance with the following formulae (4) to (6).

δ_{D,MIX}=(δ_{D1}×φ₁)+(δ_{D2}×φ₂) (4)

δ_{P,MIX}=(δ_{P1}×φ₁)+(δ_{P2}×φ₂) (5)

δ_{H,MIX}=(δ_{H1}×φ₁)+(δ_{H2}×φ₂) (6)

In the formulae (4) to (6), φ represents the volume fraction at the time of mixing, and the subscripts 1, 2 and MIX respectively represent the substance 1, the substance 2 and the mixture.

In a case where the working fluid for heat cycle is a mixture comprising n components, HSP of the working fluid for heat cycle are calculated in accordance with the following formulae (7) to (9), based on the formulae (4) to (6).

$$\begin{matrix}{δ}_{D , MIX} = {\sum }_{n = 1}^{x} ( {δ}_{D , n} \times {φ}_{n} ) & ( 7 ) \\ {δ}_{P , MIX} = {\sum }_{n = 1}^{x} ( {δ}_{P , n} \times {φ}_{n} ) & ( 8 ) \\ {δ}_{H , MIX} = {\sum }_{n = 1}^{x} ( {δ}_{H , n} \times {φ}_{n} ) & ( 9 )\end{matrix}$$

In the formulae (7) to (9), φ represents the volume fraction at the time of mixing, x represents the number of types of the substances mixed, and the subscripts n and MIX respectively represent the substance n and the mixture.

HSP [δ_{D}, δ_{P} and δ_{H}] may be estimated from the chemical structure by using, for example, computer software Hansen Solubility Parameters in Practice (HSPiP).

In this specification, the interaction distance R is represented by the following formula (10). In the formula (10), HSP of the working fluid for heat cycle comprising HFO-1123 and HFC-32 of a predetermined composition are δ_{D, HFO-1123, HFC-32}, δ_{P, HFO-1123, HFC-32} and δ_{H, HFO-1123, HFC-32} determined in accordance with the above formula (4) to (6). Further, HSP of the refrigerant oil are δ_{D, oil}, δ_{P, oil} and δ_{H, oil}.

A shorter interaction distance R means more excellent compatibility between the working fluid for heat cycle and the refrigerant oil.

R={(2×δ_{D, HFO-1123, HFC-32}−2×δ_{D, oil})²+(δ_{P, HFO-1123, HFC-32}−δ_{P, oil})²+(δ_{H, HFO-1123, HFC-32}−δ_{H, oil})²}^{1/2} (10)

Of the working fluid for heat cycle of the present invention, the interaction distance R is preferably from 0 to 14.370, more preferably from 1 to 14.347. When the interaction distance R is within the above range, a working fluid for heat cycle which is excellent in the compatibility with a greater variety of refrigerant oils and which is excellent in the general-purpose properties can be obtained.

Further, with respect to the compatibility evaluated by the above-calculated interaction distance R, particularly considering the long-term use of the working fluid for heat cycle, the interaction distance R is preferably as short as possible, whereby the refrigerant oil can stably circulate in the heat cycle system. For example, in a case where the compatibility between the working fluid and the refrigerant oil is not sufficient in a refrigerating apparatus as an example of heat cycle system equipment, the refrigerant oil discharged from a refrigerant compressor tends to remain in the cycle. As a result, the amount of the refrigerant oil in the refrigerant compressor tends to decrease, thus leading to friction by lubricity failure, or clogging of an expansion mechanism such as a capillary. That is, even very small superiority in the compatibility is considered to suppress such drawbacks and to improve long-term durability of the working fluid for heat cycle when working fluid for heat cycle and the refrigerant oil circulate in a long period of time.

A refrigerant oil having a relatively low compatibility with the working fluid for heat cycle may improve the circulation property in the heat cycle system together with the working fluid for heat cycle, by properly designing e.g. the structure of the heat cycle system equipment.

Considering the durability by the evaluation of the self-polymerizability and the compatibility, the working fluid for heat cycle of the present invention has a ratio of HFO-1123/HFC-32 of from 21/79 to 39/61, by converting the molar ratio into the mass ratio. When the ratio of HFO-1123/HFC-32 is at least 21/79, a working fluid for heat cycle excellent in the compatibility with a greater variety of refrigerant oils can be obtained. Further, when the ratio of HFO-1123/HFC-32 is at most 39/61, a working fluid for heat cycle having low self-polymerizability under pressure and temperature conditions under which the working fluid is applied to a heat cycle system, and excellent in durability can be obtained.

With a view to achieving higher compatibility with a still greater variety of refrigerant oils, the ratio of HFO-1123/HFC-32 is preferably at least 23/77, more preferably at least 25/75, further preferably at least 30/70. Further, in order to obtain a working fluid for heat cycle having low self-polymerizability even at high temperature and very excellent in durability, the ratio of HFO-1123/HFC-32 is preferably at most 37/63, more preferably at most 35/65.

In the working fluid for heat cycle of the present invention, the ratio of HFO-1123/HFC-32 is preferably from 23/77 to 39/61, more preferably from 23/77 to 37/63, further preferably from 25/75 to 37/63, particularly preferably from 25/75 to 35/65. Within such a range, a working fluid for heat cycle which has high compatibility with a still greater variety of refrigerant oils, which has higher durability and which is excellent in the cycle performance can be obtained.

Further, the working fluid for heat cycle of the present invention preferably has a global warming potential (100 years) in Intergovernmental Panel on Climate Change (IPCC), Fourth assessment report (2007) of at most 550, more preferably at most 525, from the viewpoint of the influence over global warming.

The global warming potential (100 years) of HFC-32 is 675 by a value in Intergovernmental Panel on Climate Change (IPCC), Fourth assessment report (2007), and the global warming potential (100 years) of HFO-1123 is 0.3 as a value measured in accordance with IPCC, Fourth assessment report. In this specification, unless otherwise specified, the global warming potential (GWP) is a value (100 years) in IPCC, Fourth assessment report. Further, GWP of a mixture is represented by a weighted average by the composition mass. For example, GWP of a mixture of HFO-1123 and HFC-32 in a mass ratio of 1:1 may be calculated as (0.3+675)/2=338.

In a case where the working fluid for heat cycle of the present invention contains the after-described optional component in addition to HFO-1123 and HFC-32, GWP of the working fluid for heat cycle may be obtained by weighted average of the GWP of the optional component per unit mass by the masses of the respective components in the composition.

HFO-1123 and HFC-32 form a pseudoazeotropic mixture within a range of the mass ratio of the present invention. Accordingly, the working fluid for heat cycle of the present invention has an extremely small temperature glide. The temperature glide is an index to a difference in the composition between in a liquid phase and in a gaseous phase of a mixture as the working fluid. The temperature glide is defined as properties such that the initiation temperature and the completion temperature of evaporation in an evaporator or of condensation in a condenser, for example, as the heat exchanger, differ from each other. The temperature glide of an azeotropic mixture is 0, and the temperature glide of a pseudoazeotropic mixture is extremely close to 0.

If the temperature glide is large, for example, the inlet temperature of an evaporator tends to be low, and frosting is likely to occur. Further, in a heat cycle system, the heat exchange efficiency is to be improved by making the working fluid for heat cycle and the heat source fluid such as water or the air flowing in heat exchangers flow in counter-current flow. Since the temperature difference of the heat source fluid is small in a stable operation state, it is difficult to obtain a heat cycle system with a good energy efficiency with a non-azeotropic mixture with a large temperature glide. Accordingly, in a case where a mixture is used as the working fluid, a working fluid with an appropriate temperature glide is desired.

Further, when a non-azeotropic mixture is put into a refrigerator or an air-conditioning apparatus from a pressure container, it undergoes a composition change. Further, if a refrigerant leaks out from a refrigerator or an air-conditioning apparatus, the refrigerant composition in the refrigerator or the air-conditioning apparatus is very likely to change, and a recovery to an initial refrigerant composition is hardly possible. Whereas, the above problems can be avoided with the working fluid for heat cycle of the present invention, which is a pseudoazeotropic mixture.

In the working fluid for heat cycle of the present invention, the proportion of the total amount of HFO-1123 and HFC-32 based on the entire amount of the working fluid for heat cycle is higher than 90 mass % and at most 100 mass %. By the proportion of the total amount of HFO-1123 and HFC-32 being higher than 90 mass %, a working fluid for heat cycle having an extremely small composition change and thereby having a small temperature glide, and being excellent in the balance of the properties such as durability and general-purpose properties, can be obtained. In the working fluid for heat cycle of the present invention, the proportion of the total amount of HFO-1123 and HFC-32 is preferably higher than 97 mass %, more preferably 100 mass % with a view to keeping the balance of properties such as durability and general-purpose properties.

### (Refrigerating Cycle System)

A refrigerating cycle system as an example of the heat cycle system will be described. The refrigerating cycle system is a system wherein in an evaporator, a working fluid for heat cycle removes heat energy from a load fluid to cool the load fluid thereby to accomplish cooling to a lower temperature.

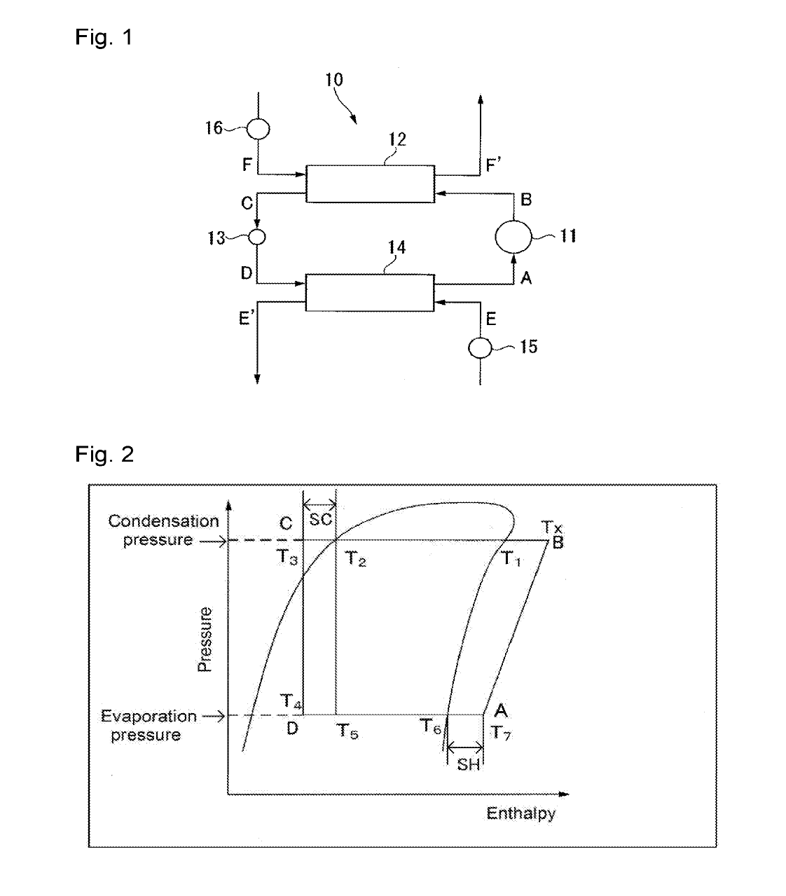

FIG. 1 is a schematic construction view illustrating an example of a refrigerating cycle system of the present invention. A refrigerating cycle system 10 is a system generally comprising a compressor 11 to compress a vapor A of a working fluid for heat cycle to form a high temperature/high pressure vapor B of the working fluid for heat cycle, a condenser 12 to cool and liquefy the vapor B of the working fluid for heat cycle discharged from the compressor 11 to form a low temperature/high pressure working fluid C for heat cycle, an expansion valve 13 to let the working fluid C for heat cycle discharged from the condenser 12 expand to form a low temperature/low pressure working fluid D for heat cycle, an evaporator 14 to heat the working fluid D for heat cycle discharged from the expansion valve 13 to form a high temperature/low pressure vapor A of the working fluid for heat cycle, a pump 15 to supply a load fluid E to the evaporator 14, and a pump 16 to supply a fluid F to the condenser 12.

In the refrigerating cyclic system 10, the following cycle is repeated.

(i) A vapor A of the working fluid for heat cycle discharged from an evaporator 14 is compressed by a compressor 11 to form a high temperature/high pressure vapor B of the working fluid for heat cycle.

(ii) The vapor B of the working fluid for heat cycle discharged from the compressor 11 is cooled and liquefied by a fluid F in a condenser 12 to form a low temperature/high pressure working fluid C for heat cycle. At that time, the fluid F is heated to form a fluid F′, which is discharged from the condenser 12.

(iii) The working fluid C for heat cycle discharged from the condenser 12 is expanded in an expansion valve 13 to form a low temperature/low pressure working fluid D for heat cycle.

(iv) The working fluid D for heat cycle discharged from the expansion valve 13 is heated by a load fluid E in the evaporator 14 to form a high temperature/low pressure vapor A of the working fluid for heat cycle. At that time, the load fluid E is cooled and becomes a load fluid E′, which is discharged from the evaporator 14.

The refrigerating cycle system 10 is a cycle system comprising an adiabatic isentropic change, an isenthalpic change and an isobaric change. The state change of the working fluid for heat cycle, as represented on a pressure-enthalpy chart as shown in FIG. 2, may be represented as a trapezoid having points A, B, C and D as vertexes.

The AB process is a process wherein adiabatic compression is carried out by the compressor 11 to change the high temperature/low pressure working fluid vapor A to a high temperature/high pressure working fluid vapor B, and is represented by the line AB in FIG. 2. As described hereinafter, the working fluid vapor A is introduced to the compressor 11 in a superheated state, and the obtainable working fluid vapor B is also a superheated vapor. The compressor discharge gas temperature (discharge temperature) is the temperature (Tx) in the state B in FIG. 2 and is the maximum temperature in the refrigerating cycle.

The BC process is a process wherein isobaric cooling is carried out in the condenser 12 to change the high temperature/high pressure working fluid vapor B to a low temperature/high pressure working fluid C and is represented by the BC line in FIG. 2. The pressure in this process is the condensation pressure. Of the two intersection points of the pressure-enthalpy chart and the BC line, the intersection point T₁ on the high enthalpy side is the condensing temperature, and the intersection point T₂ on the low enthalpy side is the condensation boiling point temperature. In a case where the working fluid is a non-azeotropic mixture fluid, the temperature glide is represented by a difference between T₁ and T₂.

The CD process is a process wherein isenthalpic expansion is carried out by the expansion valve 13 to change the low temperature/high pressure working fluid C to a low temperature/low pressure working fluid D and is presented by the CD line in FIG. 2. T₂-T₃ corresponds to the supercooling degree (SC) of the working fluid in the cycle of (i) to (iv), where T₃ is the temperature of the low temperature/high pressure working fluid C.

The DA process is a process wherein isobaric heating is carried out in the evaporator 14 to have the low temperature/low pressure working fluid D returned to a high temperature/low pressure working fluid vapor A, and is represented by the DA line in FIG. 2. The pressure in this process is the evaporation pressure. Of the two intersection points of the pressure-enthalpy chart and the DA line, the intersection point T₆ on the high enthalpy side is the evaporation temperature. T₇-T₆ corresponds to the degree of superheat (SH) of the working fluid in the cycle of (i) to (iv), where T₇ is the temperature of the working fluid vapor A. T₄ indicates the temperature of the working fluid D.

Here, cycle performance of the working fluid for heat cycle is evaluated, for example, by the refrigerating capacity (hereinafter referred to as “Q” as the case requires) and the coefficient of performance (hereinafter referred to as “COP” as the case requires) of the working fluid for heat cycle. Q and COP of the working fluid for heat cycle are obtained respectively in accordance with the following formulae (11) and (12) from enthalpies h_{A}, h_{B}, h_{C} and h_{D} in the respective states A (after evaporation, high temperature and low pressure), B (after compression, high temperature and high pressure), C (after condensation, low temperature and high pressure) and D (after expansion, low temperature and low pressure) of the working fluid for heat cycle:

Q=h_{A}−h_{D} (11)

COP=Q/compression work=(h_{A}−h_{D})/(h_{B}−h_{A}) (12)

Q represented by (h_{A}−h_{D}) corresponds to the output (kW) of the refrigerating cycle, and the compression work represented by (h_{B}−h_{A}), for example, an electric energy required to operate a compressor, corresponds to the power consumption (kW). Further, Q means a capacity to freeze a load fluid, and a higher Q means that more works can be done in the same system. In other words, it means that with a working fluid having a higher Q, the desired performance can be obtained with a smaller amount, whereby the system can be downsized.

As a heat cycle system to which the composition for a heat cycle system of the present invention is applied, a heat cycle system by a heat exchanger such as a condenser or an evaporator may be used without any particular restriction. The heat cycle system, for example, a refrigerating cycle system, has a mechanism in which a gaseous working fluid is compressed by a compressor and cooled by a condenser to form a high pressure liquid, the pressure of the liquid is lowered by an expansion valve, and the liquid is vaporized at low temperature by an evaporator so that heat is removed by the heat of vaporization.

### (Optional Component)

The working fluid for heat cycle of the present invention may optionally contain a compound commonly used as a working fluid, in addition to HFO-1123 and HFC-32, within a range not to impair the effects of the present invention.

The compound which the working fluid for heat cycle of the present invention may optionally contain in addition to HFO-1123 and HFC-32 (hereinafter referred to as an optional component) may be a HFO other than HFC-1123, a HFC having a carbon-carbon double bond other than HFC-32, a hydrocarbon, a HCFO or a CFO.

In the working fluid for heat cycle of the present invention, the total content of the optional component is less than 10 mass %, preferably less than 3 mass % in the working fluid for heat cycle (100 mass %). If the content of the optional component exceeds 10 mass %, when the working fluid is used for e.g. a refrigerant, if the working fluid leaks out from a heat cycle apparatus, the temperature glide of the working fluid for heat cycle may be large, and in addition, the balance of durability and the compatibility with the refrigerant oil may be lost.

### (HFO Other Than HFO-1123)

The HFO other than HFO-1123 which the working fluid for heat cycle of the present invention may contain, may, for example, be 1,2-difluoroethylene (HFO-1132), HFO-1261yf, HFO-1243yc, trans-1,2,3,3,3-pentafluoropropene (HFO-1225ye(E)), cis-1,2,3,3,3-pentafluoropropene (HFO-1225ye(Z)), HFO-1234yf, HFO-1234ze(E), HFO-1234ze(Z) or HFO-1243zf. The HFO may be used alone or in combination of two or more.

In a case where the working fluid for heat cycle of the present invention contains a HFO other than HFO-1123, the content is preferably from 1 to 9 mass %, more preferably from 1 to 2 mass % in the working fluid for heat cycle (100 mass %).

### (HFC Other Than HFC-32)

A HFC is a component which improves the cycle performance (capacity) of a heat cycle system. The HFC other than HFC-32 which the working fluid for heat cycle of the present invention may contain, may, for example, be HFC-152a, difluoroethane, trifluoroethane, HFC-134a, HFC-125, pentafluoropropane, hexafluoropropane, heptafluoropropane, pentafluorobutane or heptafluorocyclopentane. The HFC may be used alone or in combination of two or more.

The HFC is particularly preferably HFC-134 or HFC-152a, in view of less influence over the ozone layer and less influence over global warming.

In a case where the working fluid for heat cycle of the present invention contains a HFC other than HFC-32, the content is preferably from 1 to 9 mass %, more preferably from 1 to 2 mass % in the working fluid for heat cycle (100 mass %). The content of such a HFC may be controlled depending upon the required properties of the working fluid for heat cycle.

### (Hydrocarbon)

The hydrocarbon may, for example, be propane, propylene, cyclopropane, butane, isobutane, pentane or isopentane.

The hydrocarbon may be used alone or in combination of two or more.

In a case where the working fluid for heat cycle of the present invention contains a hydrocarbon, its content is preferably from 1 to 9 mass %, more preferably from 1 to 2 mass % in the working fluid for heat cycle (100 mass %). When the content of the hydrocarbon is at least 1 mass %, the solubility of the refrigerant oil in the working fluid for heat cycle will sufficiently improve. When the content of the hydrocarbon is at most 9 mass %, the hydrocarbon is effective to suppress combustibility of the working fluid for heat cycle.

### (HCFO, CFO)

The HCFO may, for example, be a hydrochlorofluoropropene or a hydrochlorofluoroethylene, and particularly preferred is 1-chloro-2,3,3,3-tetrafluoropropene (HCFO-1224yd) or 1-chloro-1,2-difluoroethylene (HCFO-1122) with a view to sufficiently suppressing combustibility of the working fluid for heat cycle without significantly decreasing the cycle performance (capacity) of the heat cycle system.

The HCFO may be used alone or in combination of two or more.

The CFO may, for example, be chlorofluoropropene or chlorofluoroethylene, and is particularly preferably 1,1-dichloro-2,3,3,3-tetrafluoropropene (CFO-1214ya) or 1,2-dichloro-1,2-difluoroethylene (CFO-1112) with a view to sufficiently suppressing combustibility of the working fluid for heat cycle without significantly decreasing the cycle performance (capacity) of the heat cycle system.

In a case where the working fluid for heat cycle of the present invention contains a HCFO and/or a CFO, the total content is preferably from 1 to 9 mass % in the working fluid for heat cycle (100 mass %). Chlorine atoms have an effect to suppress combustibility, and when the content of the HCFO and the CFO is within such a range, combustibility of the working fluid for heat cycle can be sufficiently suppressed without significantly decreasing the cycle performance (capacity) of the heat cycle system. Further, they are components which improve the solubility of the refrigerant oil in the working fluid for heat cycle. As the HCFO and the CFO, preferred is a HCFO which has less influence over the ozone layer and which has less influence over global warming.

### [Application to Heat Cycle System]

When the working fluid for heat cycle of the present invention is applied to a heat cycle system, it may be used as a composition for a heat cycle system of the present invention usually as mixed with a refrigerant oil. Further, the composition for a heat cycle system of the present invention may further contain a known additive such as a stabilizer or a leak detecting substance in addition to the above components.

### (Refrigerant Oil)

As a refrigerant oil, a known refrigerant oil used for a composition for a heat cycle system may be used.

The refrigerant oil may, for example, be an oxygen-containing synthetic oil (such as an ester refrigerant oil, or an ether refrigerant oil), a fluorinated refrigerant oil, a mineral oil or a hydrocarbon synthetic oil. Among them, preferred is at least one member selected from the group consisting of an ester refrigerant oil, an ether refrigerant oil and a fluorinated refrigerant oil in view of excellent compatibility with the working fluid for heat cycle.

### (Ester Refrigerant Oil)

As the ester refrigerant oil, a dibasic acid ester oil, a polyol ester oil of a polyol and a fatty acid, a complex ester oil of a polyol, a polybasic acid and a monohydric alcohol (or a fatty acid), a polyol carbonate oil or the like may be mentioned.

### (Dibasic Acid Ester Oil)

The dibasic acid ester oil is preferably an ester of a C₅₋₁₀ dibasic acid (such as glutaric acid, adipic acid, pimelic acid, suberic acid, azelaic acid or sebacic acid) with a C₂₋₁₅ monohydric alcohol which is linear or has a branched alkyl group (such as ethanol, propanol, butanol, pentanol, hexanol, heptanol, octanol, nonanol, decanol, undecanol, dodecanol, tridecanol, tetradecanol or pentadecanol). It may, for example, be specifically preferably dipentadecyl glutarate, di(2-ethylhexyl) azelate, dipentadecyl adipate, dipentadecyl suberate or diethyl sebacate.

### (Polyol Ester Oil (POE))

The polyol ester oil is an ester synthesized from a polyhydric alcohol and a fatty acid (a carboxylic acid), having a carbon/oxygen molar ratio of at least 2 and at most 7.5, preferably at least 3.2 and at most 5.8.

The polyhydric alcohol constituting the polyol ester oil may be a diol (such as ethylene glycol, 1,3-propanediol, propylene glycol, 1,4-butanediol, 1,2-butanediol, 2-methyl-1,3-propanediol, 1,5-pentanediol, neopentyl glycol, 1,6-hexanediol, 2-ethyl-2-methyl-1,3-propanediol, 1,7-heptanediol, 2-methyl-2-propyl-1,3-propanediol, 2,2-diethyl-1,3-propanediol, 1,8-octanediol, 1,9-nonanediol, 1,10-decanediol, 1,11-undecanediol or 1,12-dodecanediol), a polyol having from 3 to 20 hydroxy groups (such as trimethylolethane, trimethylolpropane, trimethylolbutane, di-(trimethylolpropane), tri-(trimethylolpropane), pentaerythritol, di-(pentaerythritol), tri-(pentaerythritol), glycerin, polyglycerin (a dimer or trimer of glycerin), 1,3,5-pentanetriol, sorbitol, sorbitan, a sorbitol/glycerin condensate, a polyhydric alcohol such as adonitol, arabitol, xylitol or mannitol, a saccharide such as xylose, arabinose, ribose, rhamnose, glucose, fructose, galactose, mannose, sorbose, cellobiose, maltose, isomaltose, trehalose, sucrose, raffinose, gentianose or melezitose, or a partially etherified product thereof), and the polyhydric alcohol constituting the ester may be used alone or in combination of two or more.

The number of carbon atoms in the fatty acid constituting the polyol ester oil is not particularly limited, but usually a C₁₋₂₄ fatty acid is employed. A linear fatty acid or a branched fatty acid is preferred. The linear fatty acid may, for example, be acetic acid, propionic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, eicosanoic acid, oleic acid, linoleic acid or linoleic acid, and the hydrocarbon group bonded to the carboxy group may be a totally saturated hydrocarbon or may have an unsaturated hydrocarbon. Further, the branched fatty acid may, for example, be 2-methylpropanoic acid, 2-methylbutanoic acid, 3-methylbutanoic acid, 2,2-dimethylpropanoic acid, 2-methylpentanoic acid, 3-methylpentanoic acid, 4-methylpentanoic acid, 2,2-dimethylbutanoic acid, 2,3-dimethylbutanoic acid, 3,3-dimethylbutanoic acid, 2-methylhexanoic acid, 3-methylhexanoic acid, 4-methylhexanoic acid, 5-methylhexanoic acid, 2,2-dimethylpentanoic acid, 2,3-dimethylpentanoic acid, 2,4-dimethylpentanoic acid, 3,3-dimethylpentanoic acid, 3,4-dimethylpentanoic acid, 4,4-dimethylpentanoic acid, 2-ethylpentanoic acid, 3-ethylpentanoic acid, 2,2,3-trimethylbutanoic acid, 2,3,3-trimethylbutanoic acid, 2-ethyl-2-methylbutanoic acid, 2-ethyl-3-methylbutanoic acid, 2-methylheptanoic acid, 3-methylheptanoic acid, 4-methylheptanoic acid, 5-methylheptanoic acid, 6-methylheptanoic acid, 2-ethylhexanoic acid, 3-ethylhexanoic acid, 4-ethylhexanoic acid, 2,2-dimethylhexanoic acid, 2,3-dimethylhexanoic acid, 2,4-dimethylhexanoic acid, 2,5-dimethylhexanoic acid, 3,3-dimethylhexanoic acid, 3,4-dimethylhexanoic acid, 3,5-dimethylhexanoic acid, 4,4-dimethylhexanoic acid, 4,5-dimethylhexanoic acid, 5,5-dimethylhexanoic acid, 2-propylpentanoic acid, 2-methyloctanoic acid, 3-methyloctanoic acid, 4-methyloctanoic acid, 5-methyloctanoic acid, 6-methyloctanoic acid, 7-methyloctanoic acid, 2,2-dimethylheptanoic acid, 2,3-dimethylheptanoic acid, 2,4-dimethylheptanoic acid, 2,5-dimethylheptanoic acid, 2,6-dimethylheptanoic acid, 3,3-dimethylheptanoic acid, 3,4-dimethylheptanoic acid, 3,5-dimethylheptanoic acid, 3,6-dimethylheptanoic acid, 4,4-dimethylheptanoic acid, 4,5-dimethylheptanoic acid, 4,6-dimethylheptanoic acid, 5,5-dimethylheptanoic acid, 5,6-dimethylheptanoic acid, 6,6-dimethylheptanoic acid, 2-methyl-2-ethylhexanoic acid, 2-methyl-3-ethylhexanoic acid, 2-methyl-4-ethylhexanoic acid, 3-methyl-2-ethylhexanoic acid, 3-methyl-3-ethylhexanoic acid, 3-methyl-4-ethylhexanoic acid, 4-methyl-2-ethylhexanoic acid, 4-methyl-3-ethylhexanoic acid, 4-methyl-4-ethylhexanoic acid, 5-methyl-2-ethylhexanoic acid, 5-methyl-3-ethylhexanoic acid, 5-methyl-4-ethylhexanoic acid, 2-ethylheptanoic acid, 3-methyloctanoic acid, 3,5,5-trimethylhexanoic acid, 2-ethyl-2,3,3-trimethylbutyric acid, 2,2,4,4-tetramethylpentanoic acid, 2,2,3,3-tetramethylpentanoic acid, 2,2,3,4-tetramethylpentanoic acid or 2,2-diisopropylpropanoic acid. The fatty acid may be an ester of one or more of such fatty acids.

The polyol constituting the ester may be used alone or as a mixture of two or more. Further, the fatty acid constituting the ester may be a single component or may be two or more types. Further, the fatty acid may be used alone or as a mixture of two or more. Further, the polyol ester oil may have a free hydroxy group.

The polyol ester oil is specifically more preferably an ester of a hindered alcohol such as neopentyl glycol, trimethylolethane, trimethylolpropane, trimethylolbutane, di-(trimethylolpropane), tri-(trimethylolpropane), pentaerythritol, di-(pentaerythritol) or tri-(pentaerythritol), further preferably an ester of neopentyl glycol, trimethylolethane, trimethylolpropane, trimethylolbutane, pentaerythritol or di-(pentaerythritol), preferably an ester of neopentyl glycol, trimethylolpropane, pentaerythritol, di-(pentaerythritol) or the like and a C₂₋₂₀ fatty acid.

The fatty acid constituting such a polyhydric alcohol/fatty acid ester may be only a fatty acid having a linear alkyl group or a fatty acid having a branched structure. A mixed ester of linear and branched fatty acids may also be employed. Further, as the fatty acid constituting the ester, two or more types selected from the above fatty acids may be used.

As a specific example, in the case of a mixed ester of linear and branched fatty acids, the molar ratio of a linear C₄₋₆ fatty acid to a branched C₇₋₉ fatty acid is from 15:85 to 90:10, preferably from 15:85 to 85:15, more preferably from 20:80 to 80:20, further preferably from 25:75 to 75:25, most preferably from 30:70 to 70:30. Further, the proportion of the total amount of a linear C₄₋₆ fatty acid and a branched C₇₋₉ fatty acid based on the entire amount of the fatty acids constituting the polyhydric alcohol/fatty acid ester is at least 20 mol %. The fatty acid composition may be selected so as to satisfy both a sufficient compatibility with the working fluid for heat cycle and a viscosity required as the refrigerant oil. Here, the proportion of the fatty acids is a value based on the entire amount of the fatty acids constituting the polyhydric alcohol/fatty acid ester contained in the refrigerant oil.

The polyol ester oil is preferably an ester of a diol (such as ethylene glycol, 1,3-propanediol, propylene glycol, 1,4-butanediol, 1,2-butanediol, 1,5-pentadiol, neopentyl glycol, 1,7-heptanediol or 1,12-dodecanediol) or a polyol having from 3 to 20 hydroxy groups (such as trimethylolethane, trimethylolpropane, trimethylolbutane, pentaerythritol, glycerin, sorbitol, sorbitan or a sorbitol/glycerin condensate) with a C₆₋₂₀ fatty acid (such as a linear or branched fatty acid such as hexanoic acid, heptanoic acid, octanoic acid, nonanoic acid, decanoic acid, undecanoic acid, dodecanoic acid, eicosanoic acid or oleic acid, or a so-called neo acid having a quaternary α carbon atom).

The polyol ester oil may have a free hydroxy group.

The polyol ester oil is preferably an ester (such as trimethylolpropane tripelargonate, pentaerythritol 2-ethylhexanoate or pentaerythritol tetrapelargonate) of a hindered alcohol (such as neopentyl glycol, trimethylolethane, trimethylolpropane, trimethylolbutane or pentaerythritol).

### (Complex Ester Oil)

The complex ester oil is an ester of a fatty acid and a dibasic acid, with a monohydric alcohol and a polyol. The fatty acid, the dibasic acid, the monohydric alcohol and the polyol may be as defined above.

### (Polyol Carbonate Oil)

The polyol carbonate oil is an ester of carbonic acid with a polyol. The polyol constituting the polyol carbonate oil may, for example, be a diol or a polyol. Further, the polyol carbonate oil may be a ring-opening polymer of a cyclic alkylene carbonate.

### (Ether Refrigerant Oil)

The ether lubricating oil may, for example, be a polyoxyalkylene compound or a polyvinyl ether.

The polyoxyalkylene compound may be a polyoxyalkylene monool or polyoxyalkylene polyol obtained by e.g. a method of polymerizing a C₂₋₄ alkylene oxide (such as ethylene oxide or propylene oxide) using as an initiator water, an alkane monool, the above diol or the above polyol. The polyoxyalkylene compound may be one having one or more of hydroxy groups of a polyoxyalkylene monool or a polyoxyalkylene polyol alkyl-etherified.

One molecule of the polyoxyalkylene compound may contain single oxyalkylene units or two or more types of oxyalkylene units. It is preferred that at least oxypropylene units are contained in one molecule.

The polyalkylene glycol oil (PAG) may be one type of the above polyoxyalkylene compound, and may, for example, be the above polyoxyalkylene monool, polyoxyalkylene diol or alkyl ether thereof.

Specifically, it may, for example, be a polyoxyalkylene compound obtained by adding a C₂₋₄ alkylene oxide to a monohydric or dihydric alcohol (such as methanol, ethanol, butanol, ethylene glycol, propylene glycol or 1,4-butanediol), or a compound having one or more of hydroxy groups of the obtained polyoxyalkylene compound alkyl-etherified. More specifically, the polyalkylene glycol oil is preferably a compound having a structure represented by R¹'O—(CH₂CH₂O)ₘ(CH₂CH(CH₃)O)ₙ—R², wherein R¹ is an alkyl group, R² is a hydrogen atom or an alkyl group, m is the degree of polymerization of the oxyethylene groups, and n is the degree of polymerization of oxypropylene groups. In a case where R² is an alkyl group, the alkyl group may be the same as or different from R¹. The alkyl group is preferably an alkyl group having at most 6 carbon atoms. m is preferably from 0 to 40, n is preferably from 6 to 80, and n is preferably equal to or larger than m.

The polyvinyl ether (PVE) may, for example, be a polymer of a vinyl ether monomer, a copolymer of a vinyl ether monomer and a hydrocarbon monomer having an olefinic double bond, or a copolymer of a vinyl ether monomer and a vinyl ether type monomer having a polyoxyalkylene chain.

The vinyl ether monomer is preferably an alkyl vinyl ether, and its alkyl group is preferably an alkyl group having at most 6 carbon atoms. The vinyl ether monomer may be used alone or in combination of two or more.

The hydrocarbon monomer having an olefinic double bond may, for example, be ethylene, propylene, various forms of butene, various forms of pentene, various forms of hexene, various forms of heptene, various forms of octene, diisobutylene, triisobutylene, styrene, α-methylstyrene or alkyl-substituted styrene. The hydrocarbon monomer having an olefinic double bond may be used alone or in combination of two or more.

The polyvinyl ether copolymer may be either of a block copolymer and a random copolymer.

### (Fluorinated Refrigerant Oil)

The fluorinated refrigerant oil may, for example, be a compound having hydrogen atoms of a synthetic oil (such as the after-mentioned mineral oil, poly-α-olefin, polyglycol or alkylnaphthalene) substituted by fluorine atoms, a perfluoropolyether oil or a fluorinated silicone oil. The fluorinated refrigerant oil may further contain a chlorine atom. The fluorinated refrigerant oil may be specifically polychlorotrifluoroethylene which is a polymer of chlorotrifluoroethylene. The degree of polymerization of chlorotrifluoroethylene in the polychlorotrifluoroethylene is preferably from 2 to 15.

The silicone oil is not particularly limited so long as it has a siloxane bond.

### (Mineral Oil)

The mineral oil may, for example, be a naphthene mineral oil or a paraffin mineral oil obtained by purifying a lubricant fraction obtained by atmospheric distillation or vacuum distillation of crude oil by a purification treatment (such as solvent deasphalting, solvent extraction, hydrocracking, solvent dewaxing, catalytic dewaxing, hydrotreating or clay treatment) optionally in combination.

### (Hydrocarbon Synthetic Oil)

The hydrocarbon synthetic oil may, for example, be an olefin synthetic oil such as poly-α-olefin, an alkylbenzene or an alkylnaphthalene.

(Poly-α-olefin)

The poly-α-olefin may be one obtained by polymerizing a hydrocarbon monomer having an olefinic double bond. The hydrocarbon monomer having an olefinic double bond may, for example, be ethylene, propylene, various forms of butene, various forms of pentene, various forms of hexene, various forms of heptene, various forms of octene, diisobutylene, triisobutylene, styrene, α-methylstyrene or alkyl-substituted styrene. The hydrocarbon monomer having an olefinic double bond may be used alone or in combination of two or more.

### (Alkylbenzene)

As the alkylbenzene, a branched alkylbenzene prepared by using as materials a polymer of propylene and benzene using a catalyst such as hydrogen fluoride, or a linear alkylbenzene prepared by using as materials n-paraffin and benzene using the above catalyst, may be used. The number of carbon atoms in its alkyl group is preferably from 1 to 30, more preferably from 4 to 20, with a view to obtaining a suitable viscosity as the lubricating oil base oil. Further, the number of alkyl groups in one molecule of the alkylbenzene depends on the number of carbon atoms in the alkyl group and is preferably from 1 to 4, more preferably from 1 to 3 in order that the viscosity is within the set range.

The refrigerant oil may be used alone or in combination of two or more.

The refrigerant oil is preferably a polyol ester oil and/or a polyalkylene glycol oil in view of the compatibility with the working fluid for heat cycle, and is particularly preferably a polyalkylene glycol oil with a view to obtaining a remarkable antioxidant effect by the after-mentioned stabilizer. The kinematic viscosity of the refrigerant oil at 40° C. is preferably from 1 to 750 mm²/s, more preferably from 1 to 400 mm²/s. Further, the kinematic viscosity at 100° C. is preferably from 1 to 100 mm²/s, more preferably from 1 to 50 mm²/s.

In the composition for a heat cycle system, the mass ratio of the working fluid for heat cycle and the refrigerant oil is within a range not to remarkably deteriorate the effects of the present invention and varies depending upon the purpose of application, the form of the compressor, etc., and is preferably from 1/10 to 10/1, more preferably from 1/3 to 3/1, particularly preferably from 2/3 to 3/2.

### (Stabilizer)

The stabilizer is a component which improves the stability of the working fluid for heat cycle against heat and oxidation. The stabilizer may, for example, be an oxidation resistance-improving agent, a heat resistance-improving agent or a metal deactivator.

The oxidation resistance-improving agent and the heat resistance-improving agent may, for example, be N,N′-diphenylphenylenediamine, p-octyldiphenylamine, p,p′-dioctyldiphenylamine, N-phenyl-1-naphthylamine, N-phenyl-2-naphthylamine, N-(p-dodecyl)phenyl-2-naphthylamine, di-1-naphthylamine, di-2-naphthylamine, N-alkylphenothiazine, 6-(t-butyl)phenol, 2,6-di-(t-butyl)phenol, 4-methyl-2,6-di-(t-butyl)phenol or 4,4′-methylenebis(2,6-di-t-butylphenol). The oxidation resistance-improving agent and the heat resistance-improving agent may be used alone or in combination of two or more.

The metal deactivator may, for example, be imidazole, benzimidazole, 2-mercaptobenzothiazole, 2,5-dimercaptothiadiazole, salicylidene-propylenediamine, pyrazole, benzotriazole, tritriazole, 2-methylbenzimidazole, 3,5-dimethylpyrazole, methylenebis-benzotriazole, an organic acid or an ester thereof, a primary, secondary or tertiary aliphatic amine, an amine salt of an organic acid or inorganic acid, a heterocyclic nitrogen-containing compound, an amine salt of an alkyl phosphate, or a derivative thereof.

The content of the stabilizer is not limited within a range not to remarkably decrease the effects of the present invention, and is usually at most 5 mass %, preferably at most 1 mass % in the composition for a heat cycle system (100 mass %).

### (Leak Detecting Substance)

The leak detecting substance may, for example, be an ultraviolet fluorescent dye, an odor gas or an odor masking agent.

The ultraviolet fluorescent dye may be known ultraviolet fluorescent dyes, such as dyes as disclosed in e.g. U.S. Pat. No. 4,249,412, JP-A-10-502737, JP-A-2007-511645, JP-A-2008-500437 and JP-A-2008-531836.

The odor masking agent may be known perfumes such as perfumes as disclosed in e.g. JP-A-2008-500437 and JP-A-2008-531836.

In a case where the leak detecting substance is used, a solubilizing agent which improves the solubility of the leak detecting substance in the working fluid for heat cycle may be used.

The solubilizing agent may be ones as disclosed in e.g. JP-A-2007-511645, JP-A-2008-500437 and JP-A-2008-531836.

The content of the leak detecting substance is within a range not to remarkably decrease the effects of the present invention, and is usually at most 2 mass %, preferably at most 0.5 mass % in the composition for a heat cycle system (100 mass %).

### (Other Compound)

The composition for a heat cycle system of the present invention may contain a C₁₋₄ alcohol or a compound used as a conventional working fluid for heat cycle, refrigerant or heat transfer fluid (hereinafter the alcohol and the compound will generally be referred to as other compound).

As such other compound, the following compounds may be mentioned.

Fluorinated ether: Perfluoropropyl methyl ether (C₃F₇OCH₃), perfluorobutyl methyl ether (C₄F₉OCH₃), perfluorobutyl ethyl ether (C₄F₉OC₂H₅), 1,1,2,2-tetrafluoroethyl-2,2,2-trifluoroethyl ether (CF₂HCF₂OCH₂CF₃, manufactured by Asahi Glass Company, Limited, AE-3000), etc.

The content of such other compound is not limited within a range not to remarkably decrease the effects of the present invention, and is usually at most 30 mass %, preferably at most 20 mass %, more preferably at most 15 mass % in the composition for a heat cycle system (100 mass %).

### (Advantageous Effects)

The working fluid for heat cycle and the composition for a heat cycle system of the present invention, which contain HFO-1123 and HFC-32 in a predetermined proportion, have higher durability and are excellent in the compatibility with a greater variety of refrigerant oils. Further, a heat cycle system excellent in the cycle performance can be obtained with them.

### [Heat Cycle System]

The heat cycle system of the present invention is a system employing the working fluid for heat cycle of the present invention. When the working fluid for heat cycle of the present invention is applied to a heat cycle system, usually the working fluid for heat cycle is applied as contained in the composition for a heat cycle system.

The heat cycle system may, for example, be a refrigerating apparatus, an air-conditioning apparatus, a power generation system, a heat transfer apparatus and a secondary cooling machine. The heat cycle system may, for example, be specifically a room air-conditioner, a store package air-conditioner, a building package air-conditioner, a plant package air-conditioner, a gas engine heat pump, a train air-conditioning system, an automobile air-conditioning system, a built-in showcase, a separate showcase, an industrial fridge freezer, a vending machine or an ice making machine.

### (Moisture Concentration)

A problem such that moisture is included in the heat cycle system may occur. Inclusion of moisture may occur due to freezing in a capillary tube, hydrolysis of the working fluid for heat cycle or the refrigerant oil, deterioration of materials by an acid component formed in the heat cycle, formation of contaminants, etc. Particularly, the above-described polyalkylene glycol oil or polyol ester oil has extremely high moisture absorbing properties and is likely to undergo hydrolysis, and inclusion of moisture decreases properties of the refrigerant oil and may be a great cause to impair the long term reliability of a compressor. Further, in an automobile air-conditioning system, moisture tends to be included from a refrigerant hose used for the purpose of absorbing vibration or a bearing of a compressor. Accordingly, in order to suppress hydrolysis of the refrigerant oil, it is necessary to control the moisture concentration in the heat cycle system. The moisture concentration in the heat cycle system is preferably less than 10,000 ppm, more preferably less than 1,000 ppm, particularly preferably less than 100 ppm by the mass ratio based on the working fluid for heat cycle.

As a method of controlling the moisture concentration in the heat cycle system, a method of using a desiccating agent (such as silica gel, activated alumina, zeolite, lithium chloride or magnesium sulfate) may be mentioned. The desiccating agent is preferably a zeolite desiccating agent in view of chemical reactivity of the desiccating agent and the working fluid for heat cycle, and the moisture absorption capacity of the desiccating agent.

The zeolite desiccating agent is, in a case where a refrigerant oil having a large moisture absorption as compared with a conventional mineral refrigerant oil is used, preferably a zeolite desiccating agent containing a compound represented by the following formula (13) as the main component in view of excellent moisture absorption capacity.

M_{2/n}O.Al₂O₃.xSiO₂.yH₂O (13)

wherein M is a group 1 element such as Na or K or a group 2 element such as Ca, n is the valence of M, and x and y are values determined by the crystal structure. The pore size can be adjusted by changing M.

To select the desiccating agent, the pore size and the fracture strength are particularly important.

In a case where a desiccating agent having a pore size larger than the molecular size of the working fluid for heat cycle is used, the working fluid for heat cycle is adsorbed in the desiccating agent and as a result, chemical reaction between the working fluid for heat cycle and the desiccating agent will occur, thus leading to undesired phenomena such as formation of non-condensing gas, a decrease in the strength of the desiccating agent, and a decrease in the adsorption capacity.

Accordingly, it is preferred to use as the desiccating agent a zeolite desiccating agent having a small pore size. Particularly preferred is sodium/potassium type A synthetic zeolite having a pore size of at most 3.5 Å. By using a sodium/potassium type A synthetic zeolite having a pore size smaller than the molecular size of the working fluid for heat cycle, it is possible to selectively adsorb and remove only moisture in the heat cycle system without adsorbing the working fluid for heat cycle. In other words, the working fluid for heat cycle is less likely to be adsorbed in the desiccating agent, whereby heat decomposition is less likely to occur and as a result, deterioration of materials constituting the heat cycle system and formation of contaminants can be suppressed.

The size of the zeolite desiccating agent is preferably from about 0.5 to about 5 mm, since if it is too small, a valve or a thin portion in pipelines of the heat cycle system may be clogged, and if it is too large, the drying capacity will be decreased. Its shape is preferably granular or cylindrical.

The zeolite desiccating agent may be formed into an optional shape by solidifying powdery zeolite by a binding agent (such as bentonite). So long as the desiccating agent is composed mainly of the zeolite desiccating agent, other desiccating agent (such as silica gel or activated alumina) may be used in combination.

The amount of the zeolite desiccating agent based on the working fluid for heat cycle is not particularly limited.

### (Non-Condensing Gas Concentration)

If non-condensing gas is included in the heat cycle system, it has adverse effects such as heat transfer failure in the condenser or the evaporator and an increase in the working pressure, and it is necessary to suppress its inclusion as far as possible. Particularly, oxygen which is one of non-condensing gases reacts with the working fluid or the refrigerant oil and promotes their decomposition. Accordingly, it is necessary to control the non-condensing gas concentration in the heat cycle system.

The non-condensing gas concentration in the heat cycle system is preferably less than 10,000 ppm, more preferably less than 1,000 ppm, particularly preferably less than 100 ppm by the mass ratio based on the working fluid for heat cycle.

### (Chlorine Concentration)

If chlorine is present in the heat cycle system, it has adverse effects such as formation of a deposit by a reaction with a metal, friction of a bearing, and decomposition of the working fluid for heat cycle or the refrigerant oil.

The chlorine concentration in the heat cycle system is preferably at most 100 ppm, particularly preferably at most 50 ppm by the mass ratio based on the working fluid for heat cycle.

### (Metal Concentration)

If a metal such as palladium, nickel or iron is present in the heat cycle system, it has adverse effects such as decomposition or oligomerization of HFO-1123.

The metal concentration in the heat cycle system is preferably at most 5 ppm, particularly preferably at most 1 ppm by the mass ratio based on the working fluid for heat cycle.

### (Acid Concentration)

If an acid is present in the heat cycle system, it has adverse effects such as oxidative destruction or acceleration of self-decomposition reaction of HFO-1123.

The acid concentration in the heat cycle system is preferably at most 1 ppm, particularly preferably at most 0.2 ppm by the mass ratio based on the working fluid for heat cycle.

Further, it is preferred to provide a means to remove an acid content by a deoxidizing agent such as NaF in the heat cycle system, for the purpose of removing the acid content from the composition for heat cycle, thereby to remove the acid content from the heat cycle composition.

### (Residue Concentration)

If a residue such as a metal powder, an oil other than the refrigerant oil or a high boiling component is present in the heat cycle system, it has adverse effects such as clogging of a vaporizer and an increase in the resistance of a rotating part.

The residue concentration in the heat cycle system is preferably at most 1,000 ppm, particularly preferably at most 100 ppm by the mass ratio based on the working fluid for heat cycle.

The residue may be removed by subjecting the working fluid for heat cycle to filtration through e.g. a filter. Further, the components (HFO-1123, HFO-1234yf and the like) of the working fluid for heat cycle may be separately subjected to filtration through a filter to remove the residue, before they are formed into a working fluid for heat cycle, and then the components are mixed to form a working fluid for heat cycle.

The above-described heat cycle system of the present invention, which employs the working fluid for heat cycle of the present invention, has high durability and is excellent in the cycle performance (capacity) and the energy efficiency. Further, due to excellent capacity, the system can be downsized.

### EXAMPLES

Now, the present invention will be described in further detail with reference to Examples. However, it should be understood that the present invention is by no means restricted thereto.

### Ex. 1

In Ex. 1, with respect to working fluids for heat cycle comprising HFO-1123 and HFC-32 having predetermined compositions, the interaction distances R from various refrigerant oils were obtained in accordance with the formula (10) employing HSP of the respective components calculated by the following method.

R={(2×δ_{D, HFO-1123, HFC-32}−2×δ_{D, oil})²+(δ_{P, HFO-1123, HFC-32}−δ_{P, oil})²+(δ_{H, HFO-1123, HFC-32}−δ_{H, oil})²}^{1/2} (10)

### (Method for Calculation of Hansen Solubility Parameters (HSP))

HSP [δ_{D}, δ_{P} and δ_{H}] of HFO-1123 and HFC-32 and the refrigerant oils were in accordance with computer software Hansen Solubility Parameters in Practice (HSPiP). With respect to substances registered in the database of HSPiP version 4.1.04, the values in the database were employed, and with respect to solvents not registered in the database, values estimated from HSPiP version 4.1.04 were employed.

Using compounds as identified in Table 1 as refrigerant oils 1 to 7, by the above method, HSP [δ_{D}, δ_{P}, δ_{H}] of the refrigerant oils and HFO-1123 were obtained. The results are shown in Table 1. In Table 1, PAG represents a polyalkylene glycol oil, PVE a polyvinyl ether, POE a polyol ester oil, and AB an alkylbenzene.

TABLE 1

| Refrigerant | Generic | Name | | | |
|---|---|---|---|---|---|
| oil | name | (molecular weight, structural formula) | δd | δp | δh |
| 1 | PAG | Polypropylene glycol dimethyl ether | 8.6 | 13.1 | 10.6 |
| | | (average molecular weight: 1,200) | | | |
| | | CH₃O—(C₃H₆O)₂₀—CH₃ | | | |
| 2 | | Polypropylene glycol/polypropylene | 9.2 | 11.3 | 11.3 |
| | | glycol dimethyl ether | | | |
| | | (average molecular weight: 1,100) | | | |
| | | CH₃O—(C₂H₄O)₁₀—(C₃H₆O)₁₀—CH₃ | | | |
| 3 | PVE | Polyethyl vinyl ether (PEV)/polyisobutyl | 13.9 | 4.7 | 4.2 |
| | | vinyl ether (PIBV) | | | |
| | | copolymer (molar ratio 7/1), (average | | | |
| | | molecular weight: 860) | | | |
| | | CH₃O—(CH₂CHOC₂H₅)₇—(CH₂CHOCH₂CH(CH₃)₂)—H | | | |
| 4 | POE | Pentaerythritol octanoate (C8 acid) | 16.2 | 2.9 | 3.2 |
| | | C—(CH₂OCOC₇H₁₅)₄ | | | |
| 5 | | Pentaerythritol nonanoate (C9 acid) | 16.9 | 2.1 | 2.6 |
| | | C—(CH₂OCOC₈H₁₇)₄ | | | |
| 6 | AB | Branched monoalkylbenzene | 16.4 | 0 | 0.9 |
| | | (C₆H₅)—CH(CH₃)CH₂—(CH(CH₃)CH₂)₃—CH(CH₃)CH₃) | | | |
| 7 | | Linear monoalkylbenzene | 16.6 | 1 | 1.7 |
| | | (C₆H₅)—CH(CH₃)CH₂—(CH₂CH₂)₄—(CH₂CH₃) | | | |

| | | | |
|---|---|---|---|
| HFO-1123 | 13.5 | 3.1 | 2.7 |
| HFC-32 | 15.6 | 9.4 | 9.1 |

Employing HSP [δ_{D}, δ_{P}, δ_{H}] of the refrigerant oils 1 to 7, HFO-1123 and HFC-32 in Table 1, the interaction distances R between the refrigerant oils 1 to 7, and the working fluids for heat cycle having compositions as identified in Table 2, were obtained in accordance with the above formula (10), to evaluate the compatibility. The results are shown in Table 2 together with the composition of each working fluid for heat cycle.

TABLE 2

| Composition of working fluid | | Interaction distance R | | | | | | |
|---|---|---|---|---|---|---|---|---|
| for heat cycle (mass %) | | Refrigerating oil | | | | | | |
| HFO-1123 | HFC-32 | 1 | 2 | 3 | 4 | 5 | 6 | 7 |
| 100 | 0 | 16.054 | 14.644 | 2.285 | 5.404 | 6.858 | 6.823 | 6.622 |
| 80 | 20 | 15.006 | 13.525 | 0.548 | 4.837 | 6.551 | 7.635 | 6.934 |
| 60 | 40 | 14.490 | 12.982 | 2.791 | 5.492 | 7.145 | 8.913 | 7.943 |
| 40 | 60 | 14.325 | 12.826 | 4.671 | 6.602 | 8.101 | 10.236 | 9.132 |
| 39 | 61 | 14.324 | 12.825 | 4.770 | 6.670 | 8.160 | 10.310 | 9.192 |
| 38 | 62 | 14.323 | 12.825 | 4.790 | 6.684 | 8.172 | 10.325 | 9.251 |
| 37 | 63 | 14.322 | 12.825 | 4.869 | 6.739 | 8.220 | 10.385 | 9.311 |
| 36 | 64 | 14.322 | 12.826 | 4.968 | 6.809 | 8.281 | 10.461 | 9.370 |
| 35 | 65 | 14.322 | 12.828 | 5.067 | 6.879 | 8.342 | 10.536 | 9.429 |
| 34 | 66 | 14.323 | 12.830 | 5.166 | 6.950 | 6.404 | 10.612 | 9.488 |
| 33 | 67 | 14.325 | 12.833 | 5.265 | 7.022 | 8.467 | 10.689 | 9.547 |
| 32 | 68 | 14.325 | 12.834 | 5.285 | 7.036 | 8.460 | 10.704 | 9.606 |
| 31 | 69 | 14.327 | 12.837 | 5.364 | 7.094 | 8.531 | 10.765 | 9.665 |
| 30 | 70 | 14.330 | 12.842 | 5.463 | 7.167 | 8.595 | 10.843 | 9.723 |
| 29 | 71 | 14.334 | 12.848 | 5.562 | 7.241 | 8.660 | 10.920 | 9.781 |
| 28 | 72 | 14.336 | 12.851 | 5.612 | 7.278 | 8.693 | 10.959 | 9.639 |
| 27 | 73 | 14.341 | 12.857 | 5.711 | 7.352 | 8.759 | 11.037 | 9.897 |
| 26 | 74 | 14.343 | 12.860 | 5.750 | 7.382 | 8.785 | 11.068 | 9.955 |
| 25 | 75 | 14.347 | 12.866 | 5.830 | 7.442 | 8.839 | 11.131 | 10.012 |
| 24 | 76 | 14.353 | 12.875 | 5.929 | 7.518 | 8.906 | 11.210 | 10.070 |
| 23 | 77 | 14.357 | 12.879 | 5.978 | 7.556 | 8.940 | 11.249 | 10.127 |
| 22 | 78 | 14.362 | 12.886 | 6.058 | 7.617 | 8.994 | 11.313 | 10.183 |
| 21 | 79 | 14.370 | 12.897 | 6.157 | 7.694 | 9.063 | 11.392 | 10.240 |
| 20 | 80 | 14.374 | 12.902 | 6.206 | 7.733 | 9.097 | 11.432 | 10.296 |
| 15 | 85 | 14.413 | 12.951 | 6.602 | 8.047 | 9.378 | 11.754 | 10.575 |
| 0 | 100 | 14.558 | 13.126 | 7.593 | 8.860 | 10.114 | 12.576 | 11.372 |

It is found from Table 2 that each of the working fluids for heat cycle having a ratio of HFO-1123/HFC-32 of at least 21/79 has R to each of the seven refrigerant oils shown in Table 1 of at most 14.370. Further, it is found that when the ratio of HFO-1123/HFC-32 is within a range of from 21/79 to 39/61, the interaction distance between each working fluid for heat cycle and each of the seven refrigerant oils shown in Table 1 is shorter than the interaction distance between HFC-32 alone and each refrigerant oil. Particularly when the ratio of HFO-1123/HFC-32 is at least 21/79, the interaction distance between each working fluid for heat cycle and each of the seven refrigerant oils is reduced with a surfficient decrease ratio, and accordingly the working fluid for heat cycle having such a composition can have an improved compatibility with a greater variety of refrigerant oils.

### Ex. 2

### (Evaluation of Refrigerating Cycle Performance, GWP and Self-Polymerizability)

With respect to each working fluid for heat cycle, the refrigerating cycle performance, GWP and the self-polymerizability were calculated and evaluated.

The refrigerating cycle performance (refrigerating capacity and coefficient of performance) was evaluated as the cycle performance (capacity and efficiency) in a case where a working fluid for heat cycle comprising HFO-1123 and HFC-32 in a proportion as identified in Table 3 was applied to a refrigerating cycle system 10 shown in FIG. 1, and a heat cycle as shown in FIG. 2, that is, adiabatic compression by a compressor 11 in the AB process, isobaric cooling by a condenser 12 in the BC process, isenthalpic expansion by an expansion valve 13 in the CD process, isobaric heating in an evaporator 14 in the DA process, were carried out.

The evaluation was conducted under temperature conditions such that the average evaporation temperature of the working fluid for heat cycle in the evaporator 14 was 0° C., the average condensing temperature of the working fluid for heat cycle in the condenser 12 was 40° C., the supercooling degree (SC) of the working fluid for heat cycle in the condenser 12 was 5° C., and the degree of superheat (SH) of the working fluid for heat cycle in the evaporator 14 was 5° C. Further, it was assumed that there was no loss in the equipment efficiency and no pressure loss in the pipelines and heat exchanger.

The refrigerating capacity and the coefficient of performance were obtained in accordance with the above formulae (11) and (12) from enthalpies h in the respective states of the working fluid for heat cycle, i.e. A (after evaporation, high temperature and low pressure), B (after compression, high temperature and high pressure), C (after condensation, low temperature and high pressure) and D (after expansion, low temperature and low pressure).

The thermodynamic properties required for calculation of the refrigerating cycle performance were calculated based on the generalized equation of state (Soave-Redlich-Kwong equation) based on the law of corresponding state and various thermodynamic equations. If a characteristic value was not available, it was calculated employing an estimation technique based on a group contribution method.

The relative performance (working fluid for heat cycle/R410A) of the refrigerating cycle performance (refrigerating capacity and coefficient of performance) of each working fluid for heat cycle based on R410A, was obtained based on the refrigerating cycle performance of R410A. The results are shown in Table 3. Further, with respect to each working fluid shown in Table 3, as described above, GWP was calculated. The results are shown in Table 3.

Further, the self-polymerizability was evaluated as described above. That is, employing the reaction rate constant k (130° C.)=2.40×10⁻¹⁰ [L·mol⁻¹·s⁻¹] of HFO-1123 obtained in accordance with the above formula (1), the HFO-1123 remaining ratio after 30 years in each working fluid for heat cycle having the composition as identified in Table 3, assuming that the working fluid for heat cycle was enclosed in a closed container under a pressure of 5.0 MPa at a temperature of 130° C., was obtained. The remaining ratio after 30 years is shown in Table 3 together with the composition of the working fluid for heat cycle, the refrigerating cycle performance and GWP.

TABLE 3

| Composition of | | | | | HFO-1123 |
|---|---|---|---|---|---|
| working fluid for | | | | | remaining |
| heat cycle (mass %) | | Relative | Relative | | ratio after |
| HFO-1123 | HFC-32 | COP | capacity | GWP | 30 years (%) |
| 100 | 0 | 0.92 | 1.15 | 0 | 72.25 |
| 40 | 60 | 0.97 | 1.18 | 405 | 89.76 |
| 39 | 61 | 0.97 | 1.18 | 412 | 90.03 |
| 38 | 62 | 0.97 | 1.18 | 419 | 90.29 |
| 37 | 63 | 0.98 | 1.18 | 425 | 90.56 |
| 36 | 64 | 0.98 | 1.18 | 432 | 90.83 |
| 35 | 65 | 0.98 | 1.18 | 439 | 91.09 |
| 34 | 66 | 0.98 | 1.17 | 446 | 91.36 |
| 33 | 67 | 0.98 | 1.17 | 452 | 91.62 |
| 32 | 68 | 0.98 | 1.17 | 459 | 91.89 |
| 31 | 69 | 0.98 | 1.17 | 466 | 92.15 |
| 30 | 70 | 0.98 | 1.17 | 473 | 92.42 |
| 29 | 71 | 0.98 | 1.17 | 479 | 92.68 |
| 28 | 72 | 0.98 | 1.16 | 486 | 92.94 |
| 27 | 73 | 0.98 | 1.16 | 493 | 93.20 |
| 26 | 74 | 0.99 | 1.16 | 500 | 93.46 |
| 25 | 75 | 0.99 | 1.16 | 506 | 93.72 |
| 24 | 76 | 0.99 | 1.16 | 513 | 93.98 |
| 23 | 77 | 0.99 | 1.16 | 520 | 94.24 |
| 22 | 78 | 0.99 | 1.15 | 527 | 94.49 |
| 21 | 79 | 0.99 | 1.15 | 533 | 94.75 |
| 20 | 80 | 0.99 | 1.15 | 540 | 95.01 |
| 10 | 90 | 1.00 | 1.13 | 608 | 97.53 |
| 0 | 100 | 1.01 | 1.11 | 675 | 99.99 |

It was confirmed from the results in Table 3 that in a working fluid for heat cycle having a ratio of HFO-1123/HFC-32 of at most 39/61, the HFO-1123 remaining ratio after 30 years is at least 90.0% and such a working fluid has low self-polymerizability.

It was found that the working fluid for heat cycle of the present invention has a coefficient of performance and a refrigerating capacity equal to or higher than those of R410A, and has GWP of at most 550. Further, it was confirmed that both the coefficient of performance and the refrigerating capacity improve by the working fluid containing HFO-1123 and HFC-32 as compared with HFO-1123 alone.

### INDUSTRIAL APPLICABILITY

The working fluid for heat cycle of the present invention is useful as a working fluid such as a refrigerant for a refrigerator, a refrigerant for an air-conditioning apparatus, a working fluid for a power generation system (such as exhaust heat recovery powder generation), a working fluid for a latent heat transport apparatus (such as a heat pipe) or a secondary cooling fluid.

This application is a continuation of PCT Application No. PCT/JP2015/057904, filed on Mar. 17, 2015, which is based upon and claims the benefit of priority from Japanese Patent Application No. 2014-055605 filed on Mar. 18, 2014. The contents of those applications are incorporated herein by reference in their entireties.

### REFERENCE SYMBOLS

10: refrigerating cycle system, 11: compressor, 12: condenser, 13: expansion valve, 14: evaporator, 15, 16: pump, A, B: vapor of working fluid for heat cycle, C, D: working fluid for heat cycle, E, E′: load fluid, F: fluid.

What is claimed is:

1. A working fluid for heat cycle, which contains trifluoroethylene and difluoromethane, wherein
the proportion of the total amount of trifluoroethylene and difluoromethane based on the entire amount of the working fluid for heat cycle is higher than 90 mass % and at most 100 mass %, and
the mass ratio represented by trifluoroethylene/difluoromethane in the working fluid for heat cycle is from 21/79 to 39/61.

2. The working fluid for heat cycle according to claim 1, wherein the mass ratio represented by trifluoroethylene/difluoromethane in the working fluid for heat cycle is from 23/77 to 39/61.

3. The working fluid for heat cycle according to claim 1, wherein the mass ratio represented by trifluoroethylene/difluoromethane in the working fluid for heat cycle is from 23/77 to 37/63.

4. The working fluid for heat cycle according to claim 1, wherein the mass ratio represented by trifluoroethylene/difluoromethane in the working fluid for heat cycle is from 25/75 to 37/63.

5. The working fluid for heat cycle according to claim 1, wherein the mass ratio represented by trifluoroethylene/difluoromethane in the working fluid for heat cycle is from 25/75 to 35/65.

6. The working fluid for heat cycle according to claim 1, wherein the proportion of the total amount of trifluoroethylene and difluoromethane based on the entire amount of the working fluid for heat cycle is higher than 97 mass % and at most 100 mass %.

7. A composition for a heat cycle system, which comprises the working fluid for heat cycle as defined in claim 1 and a refrigerant oil.

8. The composition for a heat cycle system according to claim 7, wherein the refrigerant oil is at least one member selected from an ester refrigerant oil, an ether refrigerant oil and a fluorinated refrigerant oil.

9. The composition for a heat cycle system according to claim 8, wherein the ester refrigerant oil is a polyol ester oil.

10. The composition for a heat cycle system according to claim 8, wherein the ether refrigerant oil is a polyalkylene glycol oil.

11. The composition for a heat cycle system according to claim 8, wherein the ether refrigerant oil is a polyvinyl ether.

12. A heat cycle system, which employs the composition for a heat cycle system as defined in claim 7.

13. The heat cycle system according to claim 12, which is a refrigerating apparatus, an air-conditioning apparatus, a power generation system, a heat transport apparatus or a secondary cooling machine.

14. The heat cycle system according to claim 12, which is a room air-conditioner, a store package air-conditioner, a building package air-conditioner, a plant package air-conditioner, a gas engine heat pump, a train air-conditioning system, an automobile air-conditioning system, a built-in showcase, a separate showcase, an industrial fridge freezer, an ice making machine or a vending machine.
